(19) United States
(12) Patent Application Publication
(10) Pub. No.: US 2004/0099106 A1
(43) Pub. Date: May 27, 2004

(54) Screw tool and production method thereof

(76) Inventors: Martin Strauch, Wuppertal (DE); Andre Muller, Wuppertal (DE); Oliver Pistor, Wuppertal (DE)

Correspondence Address: Martin A Farber, Suite 473, 866 United Nations Plaza, New York, NY, 10017, US

(21) Appl. No.: 10/312,644

(22) PCT Filed: Jun. 26, 2001
(86) PCT No.: PCT/EP01/07275

(30) Foreign Application Priority Data
Jun. 27, 2000 (DE) 100 31 295.0
May 15, 2001 (DE) 101 23 407.4

(51) Int. Cl. B25B 23/00

(52) U.S. Cl. 81/460

(57) ABSTRACT

A screwing tool having a torque-introduction part (2) with a cavity (4) in which a profile body (3) is inserted in a rotationally fixed manner, the profile body forming, by its section which projects out of the cavity (4), an operating end (1) for torque-transmitting insertion into a screwing-tool entry opening of a screw head, wherein the torque-introduction part (2) forms a polygonal section for inserting the screwing tool into a screwdriver mount or a bit holder, and the operating tip (1) is rotable, counter to a restoring force, in relation to the cavity-opening edge (4′) as a result of the profile body (3) being secured in the cavity (4) such that it is capable of torsion, having a torsion section (16) formed as a torsion bar. The profile body (3), which is produced from a hardened steel, forms the torsion section (16), which is fitted, by a securing section (18), in the base (4′″) of the cavity, the base being coordinated to polygonal section (17).

The invention relates to a screwing tool having a torque-introduction part with a cavity in which a profile body is inserted in a rotationally fixed manner, said profile body forming, by way of its section which projects out of the cavity, the operating end for torque-transmitting insertion into the screwing-tool entry opening of a screw head.

Such a screwdriver is described by DE 28 28 077. This document describes a screwdriver with a handle and blade. In this case, the blade, rather than forming a material-specific unit, comprises a hard steel core which has the cross-section of the desired operating tip. This steel core is retained in a shank tube by means of a plastics material or plastics casing. The two-part construction of the blade results in a low weight for the material used for the core. As a result of the small cross-section of the steel core, the latter may consist of a high-alloy steel. The shank tube does not require this. This results in a reduction in costs.

DE 198 04 081 A1 describes a chuck which has a clamping-in section and a cavity which is located opposite the clamping-in section and is intended for accommodating a screwing tool in the form of a bit. The chuck has a torsion section between the insertion section and the ¼-inch polygonal accommodating opening.

DE 41 43 218 A1 describes an apparatus for connecting screwdriver bits to a drive apparatus. In this case, in particular an elastic body which is disposed between a torque-introduction section and an operating end is provided as torsion element. The elastic body proposed by this document is a rubber layer which fills the cavity between a non-round outer part and a profile body. The profile body may be of polygonal shape here. The operating end here is inserted in a sleeve embedded in the elastic body.

The hard screwing action is damped by means of the torsion zone or the elastic body of the two chucks described above. If a threaded screw is screwed into a mating thread by an electric screwdriver, this takes place at a relatively high speed and, in the first instance, with a very low torque, since the thread friction has to be substantially overcome. However, the torque increases abruptly once the screw has been screwed in to the full extent and the screw head strikes against the workpiece or a washer. The angular momentum of the gear mechanism of the screwing tool results, in the case of the abrupt braking, in considerable torque peaks, which may destroy the screw, on the one hand, and the operating end of the screwing tool, on the other hand, if, for example, the operating end slips out of the screwing-tool entry opening. The torsion zone of the chuck and the elastic body are intended to compensate for these torque peaks. The disadvantage with this prior art is the overall size of the apparatus for damping the torque peaks.

A screwdriver bit is known from EP 0 336 136. In this case, a narrow shank region extends between the torque-introduction section, which is formed as a hexagonal component, and the operating end, which is formed as a cross-shaped profile, said shank region being capable of twisting, so that it is possible to damp torque peaks as torsion.

PCT/EP93/03504 likewise shows a torsion bit. In this case, the shank section is produced from a relatively soft material, which is likewise intended to absorb the torque peaks by torsion.

U.S. Pat. No. 3,744,350 has disclosed differently shaped chucks for accommodating bits, a torsion zone made of elastic material being provided between the end for insertion into an electric screwdriver and the accommodating end for accommodating the polygonal section of the bit. In this case, an elastic body which grips an output section in its center is positioned in a cavity of the chuck, so that the output section can be twisted relative to the casing enclosing the elastic body.

A torsion chuck with torsion element can be gathered from WO 98/55268. In this case, the torsion element is a dumbbell-shaped metal body.

The “torsion bits” of the prior art have an only insufficiently damping action since the diameter of the shank region must not drop below a certain minimum value.

It is thus an object of the invention to provide a screwing-tool bit with sufficient damping property which does not depend on the selection of chuck.

The object is achieved by the invention provided in the claims.

The configuration according to the invention provides a screwing tool in the form of a standard bit which can be inserted into any desired chuck and nevertheless has a sufficient damping property.

Claim 1 proposes, first and foremost, that the torque-introduction part forms a ¼-inch polygonal section, in particular as a standardized hexagonal section for inserting the screwing tool into a screwdriver or into a bit holder, and the operating tip can be rotated, counter to a restoring force, in relation to the cavity-opening edge as a result of the profile body being secured in the cavity such that it is capable of torsion. Assigning the profile body in a rotationally fixed manner to the torque-introduction part allows the necessary torques to be transmitted to the screw. The torque introduction takes place in a common ¼-inch polygonal section. It is thus possible for the screwing tool according to the invention to be inserted into any appropriately fitting screwdriver and any appropriately fitting chuck. The profile body is assigned to the torque-introduction part, however, such that the operating tip can yield in relation to the cavity-opening edge. This yielding takes place as rotation counter to a restoring force, so that it is elastic. Torque peaks thus result in rotation of the operating tip relative to the opening edge of the cavity, in which the profile body is inserted. In a preferred development of the invention, the profile body itself has a torsion section. This may be in the form of a torsion bar. The profile body may be secured on the torque-introduction section by virtue of an in particular polygonal end section being pressed into the base of the cup-like cavity. The torsion section may be arranged between this securing section of the profile body and the operating end. A rotary bearing may be provided adjacent to the operating end. For this purpose, the profile body may have a circular-cylindrical section which is positioned in a shape-adapted bearing cavity of the torque-introduction section. A twistable section extends between said rotary bearing and the securing section. As a result of the twistable section being mounted on both sides, it may be of relatively thin configuration. It may be formed, for example, by a through-hardened steel bar which has a thickness of 3 mm. This torsion section is enclosed by a cavity wall, at a spacing therefrom. The cavity wall may have a circular outline in this region. It may be assigned, in particular, to a shank section of the torque-introduction part which has a reduced cross-section and likewise has a circular outline. In a preferred development of the invention, the rotatability of the operating end in relation to the cavity edge is stop-limited. For this purpose, the rotary stops may be assigned to the rotary bearing itself. It is provided, in particular, that the bearing section of the profile body forms stop shoulders which interact with stop flanks of the bearing cavity which are offset at an angle thereto. It is particularly advantageous if the bearing section is assigned a step. This step, which is adjoined by the operating tip, can then rest with sliding action on the edge of the cavity opening. It is thus possible for axial forces to be kept away from the torsion section and to be introduced directly into the shank of the torque-introduction part. The torsion section is then further subjected only to torsional forces. These forces, as a result of the stop-limited rotatability of the operating end in relation to the torque-introduction part, are also limited, so that the torsion section is prevented from shearing off. The bit preferably comprises just two parts, namely the sleeve part, which consists, if appropriate, of tempered steel and into which the torque is introduced, and a hardened core part, which forms the profile body. This core part may be through-hardened. This provides the operating end with the necessary resisting force and the torsion section with the resilient rigidity required. According to a likewise preferred configuration, the stop limiting of the torsion section may be of asymmetrical configuration. It may thus be provided that the stop is reached in the screw-loosening direction, that is to say for example in the counterclockwise direction, after only brief torsion, if any at all. The screwing tool thus acts rigidly in the loosening direction. In the tightening direction, that is to say for example in the clockwise direction, it is possible to provide for stop-limited twisting capability. In this respect, the torsion action can be restricted to one direction of rotation. The invention also relates to a screwing tool in the case of which the operating end is formed by a profile body which is gripped elastically, by way of its non-round cross-sectional profile, in a cavity of the torque-introduction section, the cross-sectional profile of which is not round either. As a result of this configuration, the profile body and torque-introduction section may have different types of material. In particular, the material of the profile body may be considerably harder than that of the cavity-forming torque-introduction section. The torque-introduction section of a bit has the preferred hexagonal shape and the common ¼-inch dimension. It is also possible for the cavity to have a hexagonal outline, so that the entire torque-introduction section may be produced from a hexagonal tube. The profile body may form, in particular, a cross shape. This shape is advantageous, in particular, when the operating end is a cross-slotted profile. However, other profiles, for example Torx profiles, polygons or flat profiles, are also possible. The profile body is preferably retained in the cavity by means of an elastic body, which also produces the torsion action. The elastic body may be prefabricated, so that the profile body can be inserted into the cavity together with the elastic body. The elastic body then has the function of a dowel. It can secure the bit axially by means of positive locking. For this purpose, it is possible to provide undercuts in the dowel which interact with protrusions of the profile body. The elastic body may be of colored configuration, in order thus to perform an identification function. The elastic mounting of the profile core also in relation to the cavity walls can compensate for tilting movements. Using plastics of different levels of rigidity makes it possible to realize different resilient and damping properties which are optimum for the screwing action envisaged in each case. The profile body preferably consists of a hard metal. It may be produced by sintering. Since the amount of material used for the profile body can be reduced to a minimum, the configuration according to the invention allows inexpensive production of bits with a highly stable tip of sintered hard-metal bits. The polygonal section may consist of hardened or conventional steel or else of plastic. It is further advantageous if that section of the profile body which is inserted in the cavity is fully encased in an insulating manner by the elastic body. This then breaks any elastic conductive connection between the operating tip and the polygonal section. This insulation is beneficial for safety at work. The elastic body may be formed by a hardened liquid. The profile section is inserted into this liquid before the hardening operation. The production method in this respect provides that an elastically hardenable liquid is introduced into the cavity of the torque-introduction section. The profile body is immersed before said liquid is hardened. It is retained in the immersion position until the liquid has hardened. The elastic body preferably engages over the end side of the profile body. This then gives rise, as a result of the elastic body, not just to a twisting capability between the operating end and torque-introduction section, but the profile body can also yield slightly in the axial direction; clipping is also possible. In a preferred configuration, the profile body forms a continuous profile, in particular a cross profile or a flat profile. As a result of this configuration, the profile body may be extruded and then deflected correspondingly. The extrusion method is also possible if the profile body forms a star shape or a flat shape. It is always beneficial if the profile body has the profile of its operating section or a polygon over its entire length. It is regarded as being advantageous that the operating tip only has to be formed to the extent required by the maximum screwing-penetration depth. This results in a screwing-depth stop in the bit with the plastics material butting against the screwing location without being adversely affected. A development of the invention provides that the profile body is formed as an operating end at each of its two ends. The two ends then project out of the cavity of the polygonal section, so that the bit can be turned round. If such a double bit is inserted into an appropriately fitting chuck, then the latching ball of the chuck can project into the corner recesses of the polygonal section. The tip of one operating end may then be supported on the base of the chuck. In a variant of the invention, the elastic body has a multiplicity of rods extending parallel to the axis of the profile body. These rods are located between the ribs of the profile body and the inner wall of the cavity having said polygonal profile.

Exemplary embodiments of the invention are explained hereinbelow with reference to accompanying drawings, in which:

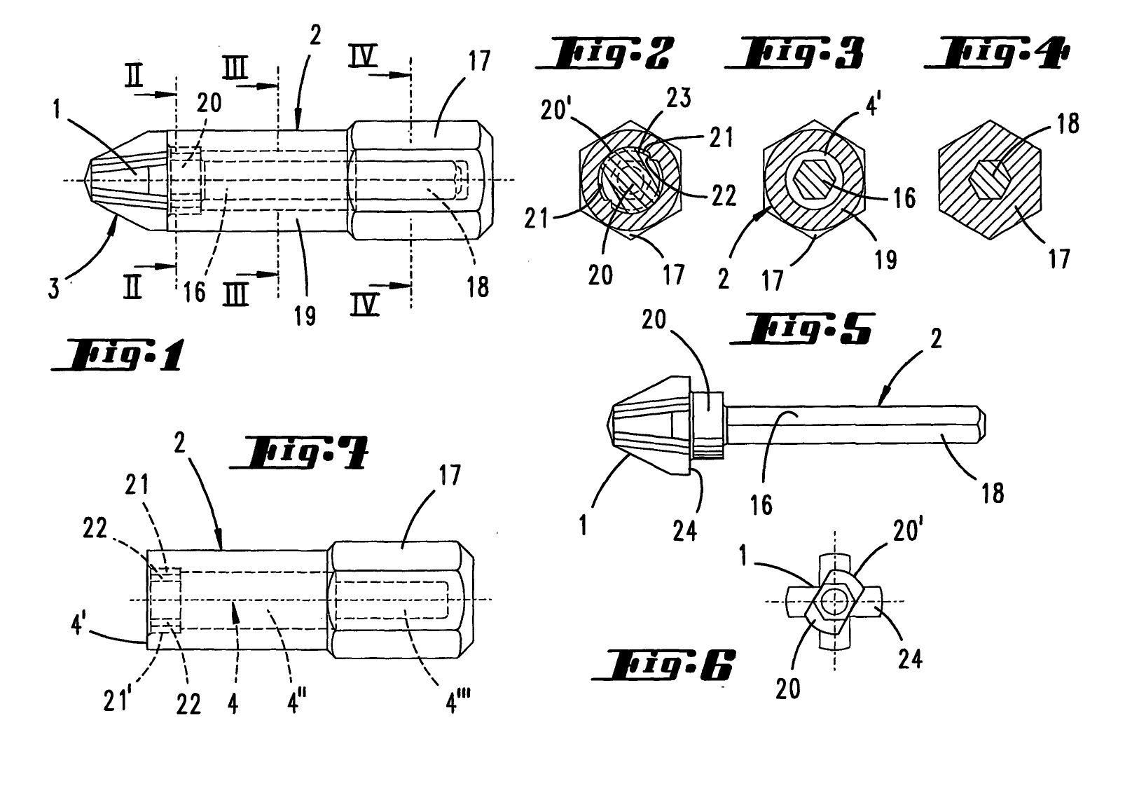

FIG. 1 shows a first exemplary embodiment of the invention in elevation,

FIG. 2 shows a section along line II-II in FIG. 1,

FIG. 3 shows a section along line III-III in FIG. 1,

FIG. 4 shows a section along line IV-IV in FIG. 1,

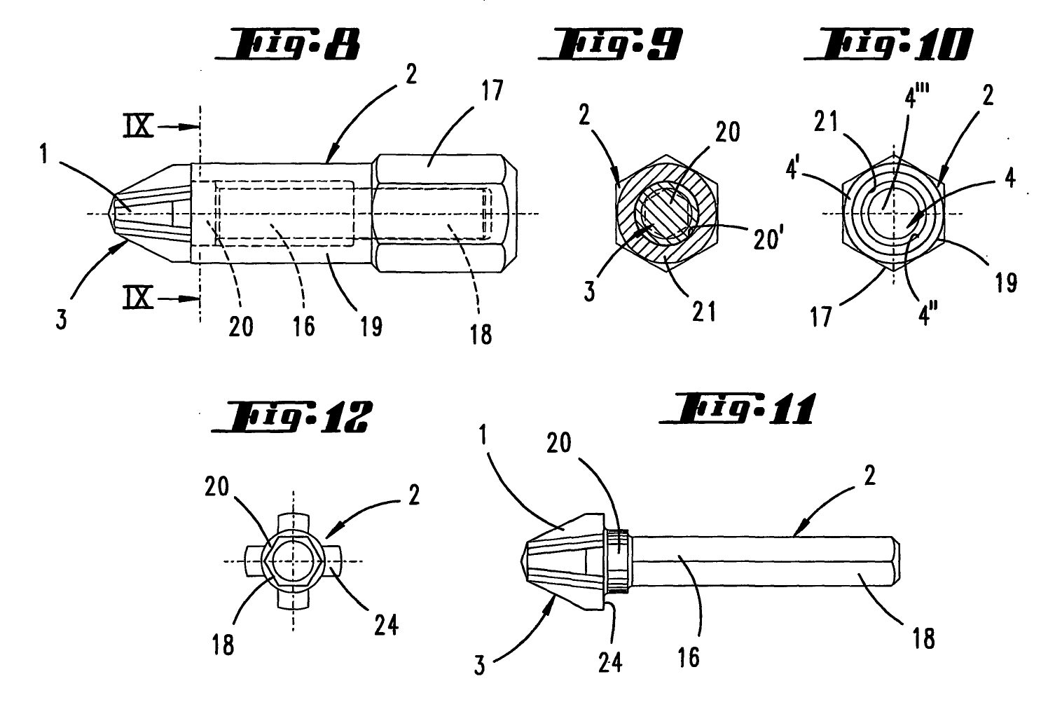

FIG. 5 shows the profile body in elevation,

FIG. 6 shows the profile body in side view,

FIG. 7 shows the torque-introduction part, formed as a sleeve, in elevation,

FIG. 8 shows a second exemplary embodiment in an illustration according to FIG. 1,

FIG. 9 shows a section along line IX-IX,

FIG. 10 shows the plan view of the opening of the cavity of the torque-introduction part,

FIG. 11 shows the profile body of the second exemplary embodiment,

FIG. 12 shows a rear view of the profile body according to FIG. 11,

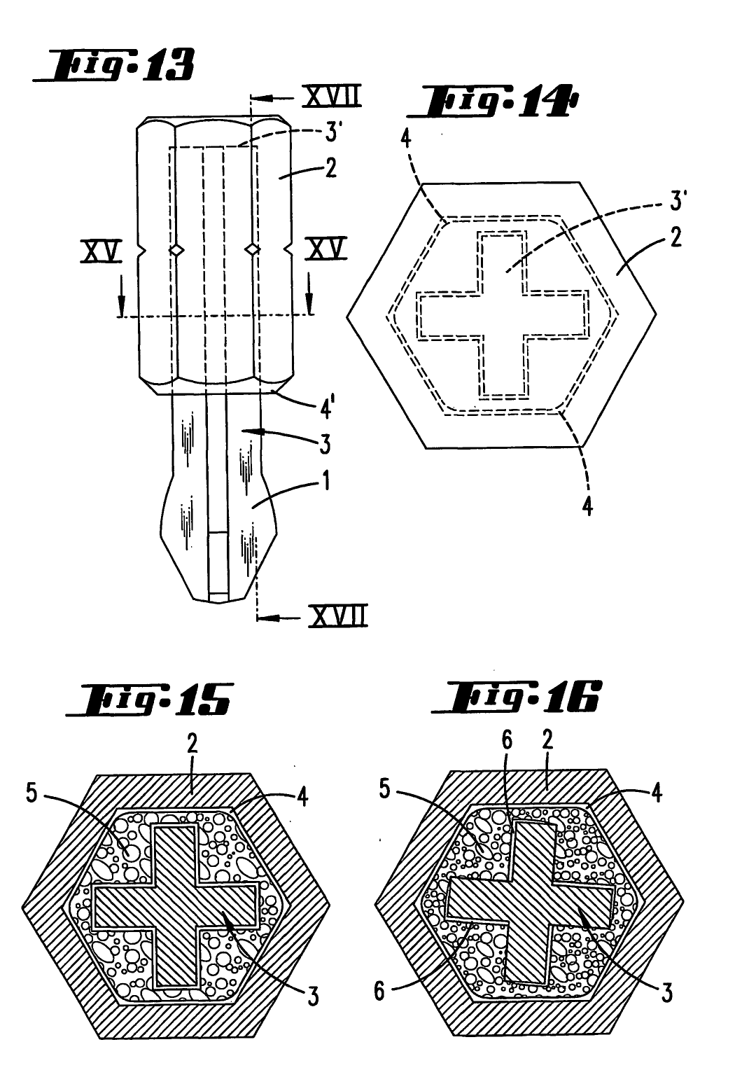

FIG. 13 shows, in elevation, a third exemplary embodiment of a screwing tool according to the invention in the form of a bit,

FIG. 14 shows the third exemplary embodiment in plan view,

FIG. 15 shows a section along line XV-XV in FIG. 13,

FIG. 16 shows an illustration according to FIG. 15 with the torque applied and the elastic body twisted,

FIG. 17 shows a section along line XVII-XVII in

FIG. 13,

FIG. 18 shows an illustration according to FIG. 15 of a fourth exemplary embodiment,

FIG. 19 shows a fifth exemplary embodiment in side view,

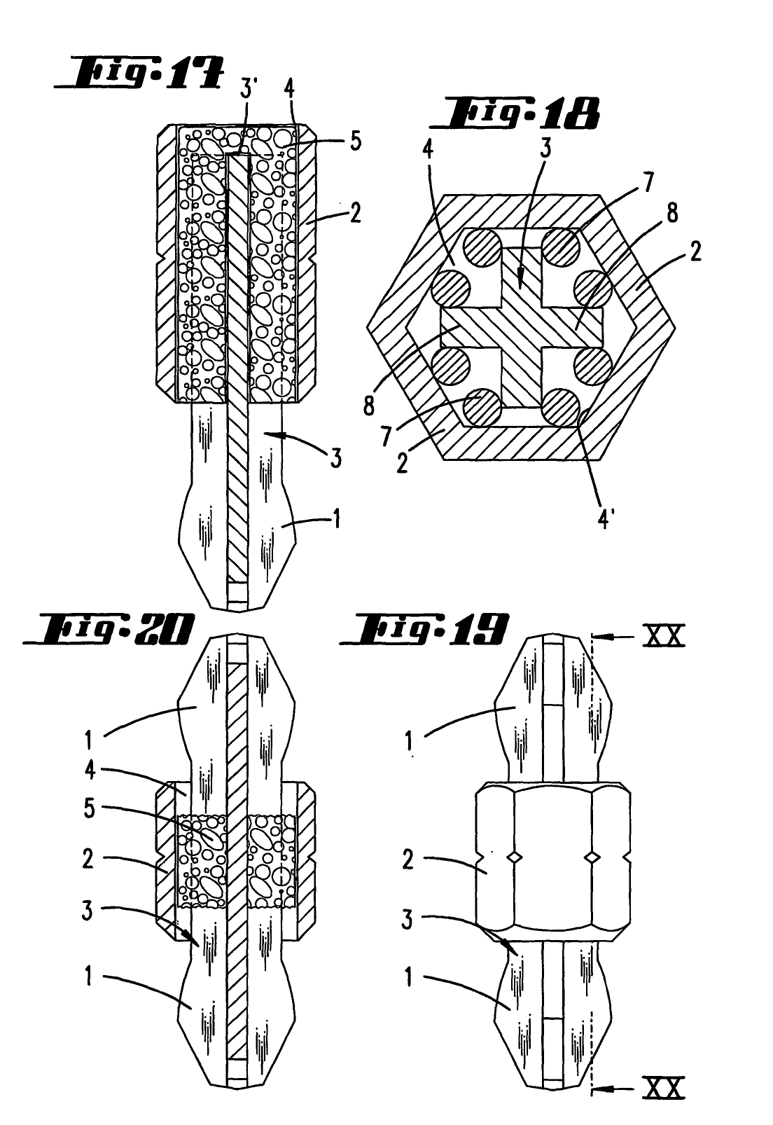

FIG. 20 shows a section along line XX-XX in FIG. 19,

FIG. 21 shows a further exemplary embodiment in the manner of FIG. 19,

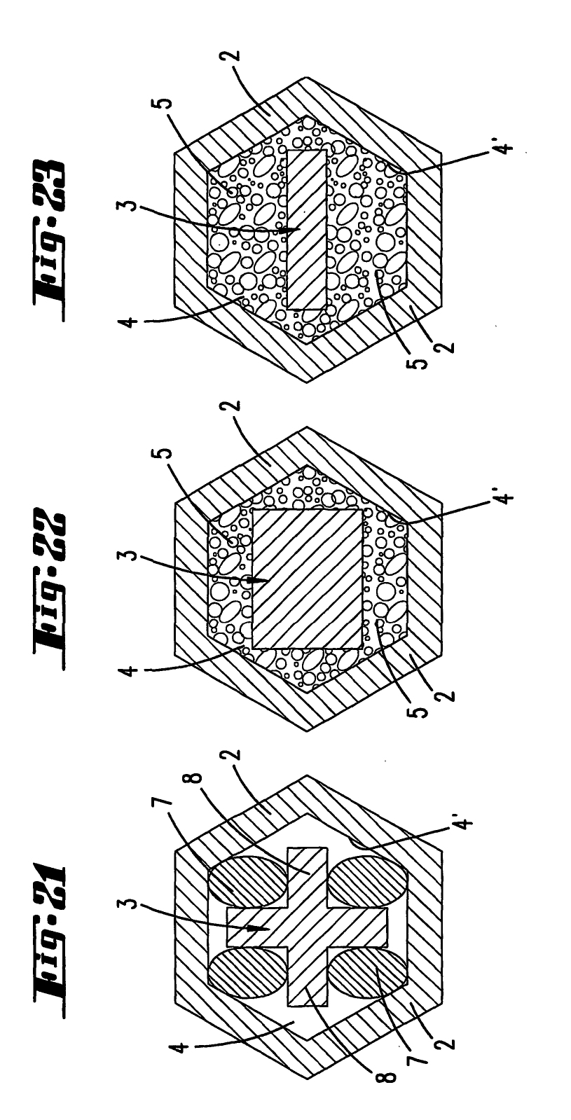

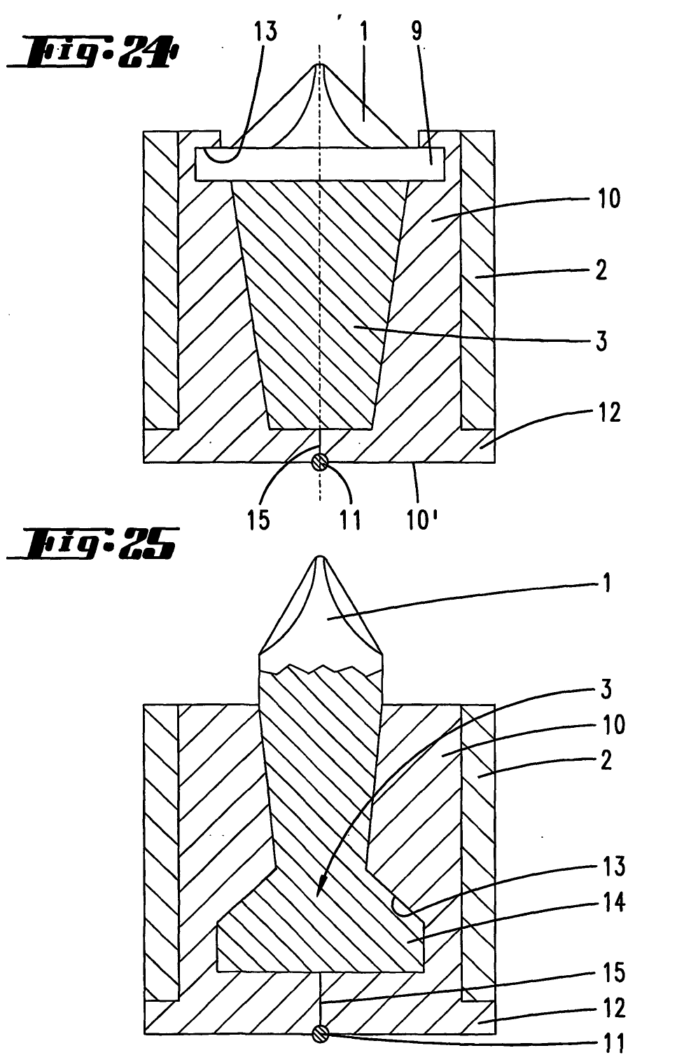

FIG. 22 shows a further exemplary embodiment with a polygonal profile body,

FIG. 23 shows a further exemplary embodiment with a flat profile body,

FIG. 24 shows a longitudinal section through a further exemplary embodiment, in the case of which the dowel is in two parts, and

FIG. 25 shows a further exemplary embodiment in an illustration according to FIG. 24.

The exemplary embodiments illustrated in FIGS. 1-12 comprise two steel parts: a sleeve-like steel part 2, which is the torque-introduction part, and a core part made of a hardened steel, which is the profile body 3. The profile body 3 forms an operating end 1, which in the exemplary embodiment is formed as a cross-slotted profile. At the rear of the operating end 1, the profile body 3 has a step 24. The step 24 is adjoined by a bearing section 20. In the case of the first exemplary embodiment, the bearing section 20 has two rounded sections 20′ and planar sections 23 running parallel to one another. The bearing section 20 is adjoined by a hexagonal torsion-bar section which has a material thickness of 3 mm. This section forms, in the first instance, a torsion section 16 and, at its end, a securing section 18.

The second part, which [lacuna] a sleeve part 2 consisting, in particular, of soft steel, has a polygonal section 17, which has a standard ¼-inch hexagonal profile. This polygonal section 17 is adjoined by a shank section 19, which has a circular-cylindrical outline contour. The sleeve part 2 serves for introducing the torque via the polygonal section 17. It has an axial cavity in the form of a multi-stepped blind bore. It is also possible, however, for the sleeve part 2 to consist of hard material. This is beneficial for the service life of the tool.

This cavity 4 directly adjoins a cavity-opening edge 4′ of the end surface of the shank 19. This circular cavity section forms a bearing cavity 21 with a bearing-cavity wall 21′, on which the curved surface 20′ of the bearing section 20 is guided with sliding action. Toward the inside of the cavity, the bearing cavity 21 is adjoined by a cavity section 4″ which is assigned to the torsion section 16. This cavity section 4″ extends substantially over the entire shank section 19. The cavity section 4″ is adjoined by a smaller-diameter cavity section 4′″. This is a pressing-in section for the securing end 18 of the profile body 3. It is produced with a corresponding undersize, so that the securing section 18 is retained there with a clamping fit. The securing section 18 is pressed into the cavity section 4′″ until the shoulder 24 comes into abutment with the cavity-opening edge 4′, on which it can slide.

In the case of the second exemplary embodiment (FIGS. 8-12), the bearing section 20 is circular. In the case of this exemplary embodiment, the rotary movement of the operating end 1 in relation to the cavity-opening edge 4′ is not limited.

In the case of the first exemplary embodiment, the operating end can only be rotated over a certain angle range in relation to the cavity-opening edge 4′. For this purpose, the bearing cavity 21 has radially inwardly directed protrusions, which form stop flanks 22 against which the abutment shoulders 23 of the bearing section 20 can strike. The torsion section 16 is thus secured against shearing off.

In the case of a further exemplary embodiment, which is not illustrated in the figures, it is provided that the torsion section can only rotate in one direction of rotation, for example the clockwise direction. For this purpose, the stop flanks 22, 23 located one upon the other, and oriented in the counterclockwise direction, are in abutment in the position in which they are not subjected to any force. If the screwing tool is displaced in this direction, it acts rigidly since, from the start, the torque is transmitted via the two abutting stop flanks 22, 23. If the screwing tool, in contrast, is rotated in the opposite direction of rotation, then the torque is transmitted, in the manner described above, via the torsion section until the stop flank 22 belonging to this direction of rotation comes into contact with the stop shoulder 23.

Functioning is as follows:

If the operating end 1 is inserted in a screw head 1 and the polygonal section 17 is subjected to a torque, the latter, in the first instance, is introduced into the operating end 1 via the torsion section, which has a length of approximately 10 mm. In this case, the operating end rotates by a certain angle in relation to the cavity-opening edge 4′, which in the first instance is not subjected to torsional loading. In the case of the first exemplary embodiment, the operating end 1 can rotate in relation to the cavity-opening edge 4′ until the stop shoulder 23 strikes against the stop flank 22 of the sleeve part. From then on, the sleeve part 2 contributes to the torque transmission.

As a result of this configuration, it is possible to use a torsion member, of only 3 mm in thickness, in the form of a torsion bar with in particular a polygonal cross-section, the effective torsion length thereof being approximately three times as long as the thickness. Overall, the screwing tool has a length of only approximately 25 mm.

The connection of the securing section 18 in the region of the base of the cavity 4 may also take place in some other way. For example, it is conceivable for the securing section 18 to be adhesively bonded or welded there. Riveting is also possible.

The screwdriver bits illustrated in the following exemplary embodiments (FIGS. 13-25) have a profile body 3. This profile body 3 is in the cross-sectional shape of a cross. That end of the profile body 3 which is directed away from the operating end 1 is inserted in a cavity 4 of a hexagonal-tube section 2, which has a ¼-inch outer dimension, in order for it to be possible for it to be inserted into standardized chucks.

The cavity 4 may have a base. It is also possible, however, for it to be open. The width of the cross section of the profile body 3 is smaller than the spacing between two opposite inner-wall surfaces 4′ of the cavity 4, so that the profile body 3 is positioned with play in the cavity 4. In the case of the third exemplary embodiment illustrated in FIGS. 13-17, the interspace between the cross profile and the polygonal cavity 4′ is filled by an elastic body 5. The elastic body 5 allows rotatability of the core, formed by the profile body 3, in relation to the casing, formed by the hexagonal section 2. Such twisting produces the gaps 6 illustrated in FIG. 16. The elastic body 5 has a sufficiently high restoring force in order to move the cross body 5 into the position illustrated in FIG. 15 again.

The elastic body 5 may be prefabricated, so that, in the first instance, it can be pushed onto the profile body 3, in order then to be pushed, together with the profile body 3, into the cavity 4. The elastic body 5 preferably has a certain oversize, so that it is secured in a friction-fitting manner in the cavity 4. It is possible here for elastic material to engage over the end side 3′ of the hexagonal section 2. This serves, on the one hand, for stabilization of the profile body 3 and, on the other hand, for axial resilience.

It is also possible for the elastic body 5 to be formed from a multiplicity of rods 7 or ribs which project from a foot region located over the end side 3′. The rods may be positioned in each case against the ribs 8 of the profile body 3. At the same time, the rods 7, which may have a round or else polygonal cross-section, butt against the inner wall 4′ of the cavity 4. By virtue of deformation, these rods act in a damping manner (FIGS. 18, 21).

It is regarded as advantageous if the profile body 3 is symmetrical about a smaller number of axes, for example has a four-fold symmetry, than the cavity 4, which preferably has a six-fold symmetry.

In the case of the exemplary embodiment illustrated in FIGS. 19 and 20, the torque-introduction section 2 is formed as a hexagonal sleeve. An elastic body 5 is located in the central region of the sleeve. Operating ends of one and the same profile body 3 project out of both end openings of the hexagonal sleeve 2. The bit can thus be turned round.

The elastic body may be formed by a hardenable liquid. This is introduced for example in the first instance into the cavity of the hexagonal section. Thereafter, the profile section of the profile body 3 is inserted therein. Once the liquid has solidified, the profile body 3 is secured elastically in the cavity of the hexagonal section 2. The liquid may be a synthetic resin. It is also possible, however, for the liquid to be a metal alloy which is made to melt. The profile section of the profile body 3 is then inserted into the melt and retained there following solidification. In order for the profile body 3 to be better secured in the cavity 4 of the hexagonal section 2, the profile section may form protrusions or undercuts. Such undercuts or protrusions may also form the side wall of the cavity 4, so that it is ensured that the profile body 3 is secured on the hexagonal section 2 in a positively locking manner by means of the elastic body 5.

That section of the profile body 3 which is secured by the elastic body 5 preferably has a polygonal configuration. It may also be formed as a flat body.

In the case of the exemplary embodiment illustrated in FIGS. 24 and 25, the elastic body 5 forms a dowel 10 which comprises two halves. The dowel 10 may be swung open about a hinge line 11. The dowel 10 has a recess into which the profile body 3 can be inserted in a shape-adapted manner. The profile body 3 forms protrusions. In the case of the exemplary embodiment according to FIG. 12, these protrusions are disposed in the vicinity of the tip 1. An annular collar 9 is provided there, said collar projecting radially and engaging in a groove 13 of the dowel 10, so that the profile body 3 is secured axially. The dowel 10 extends beyond the hexagonal section 2 by way of a projection 12. The end side 10′ of the dowel 10 is supported on the base of a chuck when the screwing tool is being used, so that axial forces which act on the tip 1 are transmitted into the chuck. Tensile forces which act on the profile body 3 are directed into the undercuts 13 and, via the projection 12, into the hexagonal section 2, which is secured axially in the chuck.

In the case of the exemplary embodiment according to FIG. 25, the secured profile section of the profile body 3 has wings 14 which are positioned in corresponding recesses 13 of the dowel 10. This dowel is also in two parts and forms a parting plane 15.

In a variant of the invention, the elastic body 5 may be injection molded directly onto the profile body 3. In a second injection-molding step, the hexagonal section 2 may be molded onto the plastics elastic body 5. In this case, the hexagonal section 2 may consist of a more rigid plastics material than the elastic body 5. Production may take place in a single plastics injection mold, specifically by multi-component injection molding in the case of which, in the first instance, the profile body 3 is positioned in the mold cavity and then, in a known manner, the profile body is encapsulated by injection molding.

A possible material for the profile body 3 is preferably a sintered hard metal. As an alternative, however, it is also possible to use a steel coated with hard material.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

1. A screwing tool having a torque-introduction part (2) with a cavity (4) in which a profile body (3) is inserted in a rotationally fixed manner, said profile body forming, by way of its section which projects out of the cavity (4), the operating end (1) for torque-transmitting insertion into the screwing-tool entry opening of a screw head, characterized in that the torque-introduction part (2) forms a standardized hexagonal section for inserting the screwing tool into a screwdriver mount or a bit holder, and the operating tip (1) can be rotated, counter to a restoring force, in relation to the cavity-opening edge (4′) as a result of the profile body (3) being secured in the cavity (4) such that it is capable of torsion.

2. The screwing tool as claimed in claim 1 or in particular as claimed therein, characterized in that the profile body (3) has a torsion section (16).

3. The screwing tool as claimed in one or more of the preceding claims or in particular as claimed therein, characterized in that the profile body (3) is secured on the torque-introduction part (2) by virtue of a polygonal end section (18) being pressed into the base (4′″) of the cup-like cavity (4).

4. The screwing tool as claimed in one or more of the preceding claims or in particular as claimed therein, characterized by a twistable section (16) which extends between a rotary bearing (20, 21), adjacent to the operating end (1), and a securing section (18), which is connected to the torque-introduction part (2) at a location remote from the opening (4′) of the cavity (4).

5. The screwing tool as claimed in one or more of the preceding claims or in particular as claimed therein, characterized in that the securing section (18) and the torsion section (16) are formed by an in particular polygonal torsion bar which has a thickness of approximately 3 mm.

6. The screwing tool as claimed in one or more of the preceding claims or in particular as claimed therein, characterized in that the cavity section which encloses the torsion section (16), at a spacing therefrom, is assigned to a shank (19) which has a reduced cross-section and, in particular, a circular outline.

7. The screwing tool as claimed in one or more of the preceding claims or in particular as claimed therein, characterized by an in particular asymmetrical stop-limited twisting capability of the torsion section (16).

8. The screwing tool as claimed in one or more of the preceding claims or in particular as claimed therein, characterized in that rotary stops (22, 23) are provided in the region of the rotary bearing (20, 21).

9. The screwing tool as claimed in one or more of the preceding claims or in particular as claimed therein, characterized by a bearing section (20) of the profile body (3), said bearing section forming stop shoulders (23) which interact with stop flanks (22) of the bearing cavity (21) which are offset at an angle.

10. The screwing tool as claimed in one or more of the preceding claims or in particular as claimed therein, characterized in that the bearing section (20) forms a step (24) which slides on the edge (4′) of the cavity opening.

11. The screwing tool as claimed in one or more of the preceding claims or in particular as claimed therein, characterized in that the profile body (3) is gripped elastically, by way of its non-round cross-sectional profile, in the cavity (4) of the torque-introduction section (2), the cross-sectional profile of which is not round either.

12. The screwing tool as claimed in one or more of the preceding claims or in particular as claimed therein, characterized in that the profile body (3) forms a polygon, a star-shaped profile or a cross-shaped profile.

13. The screwing tool as claimed in one or more of the preceding claims or in particular as claimed therein, characterized in that the profile body (3) is retained in the cavity (4) by means of an elastic body (5).

14. The screwing tool as claimed in one or more of the preceding claims or in particular as claimed therein, characterized in that the profile body (3) consists of hard metal and, in particular, is sintered or consists of hardened steel.

15. The screwing tool as claimed in one or more of the preceding claims or in particular as claimed therein, characterized in that the elastic body (5) is a dowel-like insert element.

16. The screwing tool as claimed in one or more of the preceding claims or in particular as claimed therein, characterized in that the profile body (3) is secured axially by the dowel (10) by means of protrusions (9, 14) positioned in undercuts (13).

17. The screwing tool as claimed in one or more of the preceding claims or in particular as claimed therein, characterized in that that section of the profile body (3) which is inserted in the cavity (4) is encased in an insulating manner by the elastic body (5).

18. The screwing tool as claimed in one or more of the preceding claims or in particular as claimed therein, characterized in that the dowel (10) has two in particular hinged halves.

19. The screwing tool as claimed in one or more of the preceding claims or in particular as claimed therein, characterized in that the elastic body (5) is formed by a hardened liquid, in which the profile section (3) is immersed before the hardening operation.

20. The screwing tool as claimed in one or more of the preceding claims or in particular as claimed therein, characterized in that the elastic body (5) engages over the end side (3′) of the profile body (3).

21. The screwing tool as claimed in one or more of the preceding claims or in particular as claimed therein, characterized in that the profile body (3) projects out of the cavity (4) by way of two ends each formed as operating end (1).

22. The screwing tool as claimed in one or more of the preceding claims or in particular as claimed therein, characterized in that the elastic body (5) forms rods (7) located between the ribs (8) of the profile body (3) and the inner wall (4′) of the cavity.

23. The screwing tool as claimed in one or more of the preceding claims or in particular as claimed therein, characterized in that the cavity (4) is of polygonal shape and forms in particular a hexagonal cross-section.

24. A method of producing a screwing tool as claimed in one of the preceding claims, characterized in that an elastically hardenable liquid is introduced into the cavity (4) of the torque-introduction section (2), the profile body (3) being immersed in said liquid before the hardening operation.

25. The method of producing a screwing tool as claimed in one or more of the preceding claims or in particular as claimed therein, characterized in that the hexagonal section (2) is molded around the elastic body (5), which is molded onto the profile body (3).

26. The method of producing a screwing tool as claimed in one or more of the preceding claims or in particular as claimed therein, characterized in that the screwing tool is produced by multi-component injection molding.
